(19) United States
(12) Patent Application Publication
(10) Pub. No.: US 2019/0095953 A1
(43) Pub. Date: Mar. 28, 2019

(54) PROMOTION RECOMMENDATIONS BASED ON USER REJECTIONS

(71) Applicant: Target Brands, Inc., Minneapolis, MN (US)

(72) Inventors: Tony Alton Swenson, Cannon Falls, MN (US); Kristen Leigh Tegen, Saint Louis Park, MN (US)

(21) Appl. No.: 15/718,939

(22) Filed: Sep. 28, 2017

(51) Int. Cl. G06Q 30/02

(52) U.S. Cl. CPC G06Q 30/0264

(57) ABSTRACT

A computer-implemented method includes providing a user interface having a promotion list with a first inactive retail promotion and a first control for approving or rejecting the first inactive retail promotion. An indication is received from the first control that the first inactive retail promotion is rejected and in response, a filter is created to prevent inactive retail promotions that match at least one aspect of the first inactive retail promotion from being placed in a second promotion list.

### BACKGROUND

Promotions or offers are discounts that retailers provide to consumers to entice consumers to purchase products and services. Promotions are planned several weeks or months in advance. In large scale retail operations, promotions are scheduled for thousands of products with many products having multiple different promotions scheduled for different weeks of the year.

The discussion above is merely provided for general background information and is not intended to be used as an aid in determining the scope of the claimed subject matter. The claimed subject matter is not limited to implementations that solve any or all disadvantages noted in the background.

### SUMMARY

A computer-implemented method includes providing a user interface having a promotion list with a first inactive retail promotion and a first control for approving or rejecting the first inactive retail promotion. An indication is received from the first control that the first inactive retail promotion is rejected and in response, a filter is created to prevent inactive retail promotions that match at least one aspect of the first inactive retail promotion from being placed in a second promotion list.

In accordance with a further embodiment, a processor in a computing device executes instructions to identify a first retail promotion and generating a user interface that displays the first retail promotion together with a control for approving or rejecting the first retail promotion. The processor receives an indication that the control for the first retail promotion has been used to reject the first retail promotion and in response creates a filter to prevent retail promotions that match at least one aspect of the first retail promotion from being displayed in a second user interface.

In a still further embodiment, a user interface comprising at least one recommended promotion and an overview area containing a count of a number of recommended promotions and a count of a number of rejected promotions is generated. An indication that a user has rejected a single recommended promotion is received and in response, a second user interface is generated in which the displayed count of the number of recommended promotions is decreased by at least two.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a flow diagram of a method in accordance with one embodiment.

FIG. 2 is a block diagram of a system in accordance with one embodiment.

FIG. 3 is an example user interface for requesting promotion recommendations in accordance with one embodiment.

FIG. 4 is an example of a promotions recommendation user interface in accordance with one embodiment.

FIG. 5 is an example of a reason for rejection user interface in accordance with one embodiment.

FIG. 6 is an example recommended promotions user interface after a promotion has been rejected in accordance with one embodiment.

FIG. 7 is an example recommended promotions user interface after new request for recommended promotions has been made after a promotion has been rejected in accordance with one embodiment.

FIG. 8 is an example recommended promotions user interface after a promotion has been accepted in accordance with one embodiment.

FIG. 9 is a block diagram of a computing device used in accordance with various embodiments.

### DETAILED DESCRIPTION

When offering promotions, a retailer is attempting to maximize their profits even though they are reducing the price of the goods they are selling. Identifying what is the best promotion to apply to a product is computationally challenging since the demand for a product is dependent on several factors including previous prices, previous demand for the product, seasonality effects, a baseline demand, and the change in demand due to the change in the promotional price. Recently, computerized systems have been used to generate recommended promotions using complex algorithms to predict the demand of several different possible promotions and selecting the promotions that will provide the highest income for the retailer. Unfortunately, such computerized systems sometime recommend promotions that for one reason or another are unacceptable to the retailer. As such, the computer-based recommendations cannot be used directly by the retailer but instead must be reviewed before being implemented.

For large retailers, a large number of recommended promotions are generated by the computer system. This large number makes the review process time consuming. As such, innovations are needed to improve the operation of the computer used to perform the promotion reviews.

The embodiments described herein provide improvements to the computer that reduce the number of operations that must be performed by the computer system to facilitate review of the promotions recommended by the promotions recommendation engine. In particular, the embodiments described herein automatically generate a filter to filter out certain promotions when a reviewer indicates that a single promotion is being rejected. Thus, upon receiving an indication that a single promotion is rejected, the embodiments create a filter that will automatically filter out recommended promotions that match the single rejected promotion. By automatically filtering out these other recommended promotions without receiving an indication that the user wishes to reject those promotions, the embodiments reduce the number of input and output operations that must be performed since the system does not need to receive input for any of the matching promotions in order to remove the promotions from a list of recommended promotions.

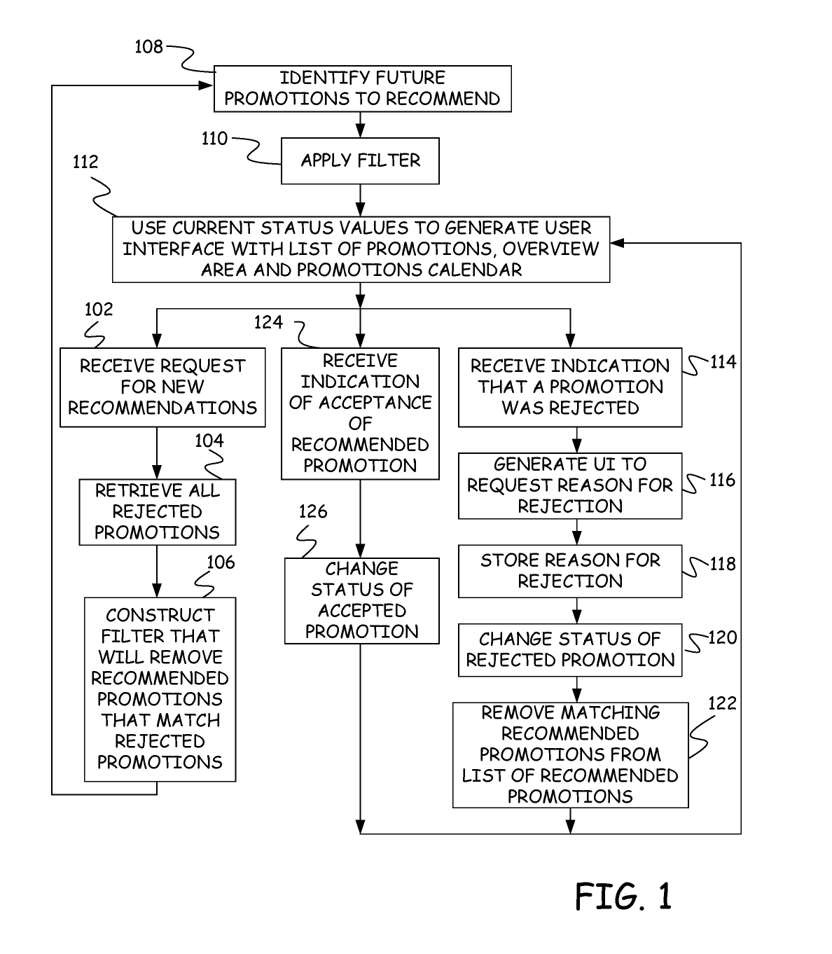

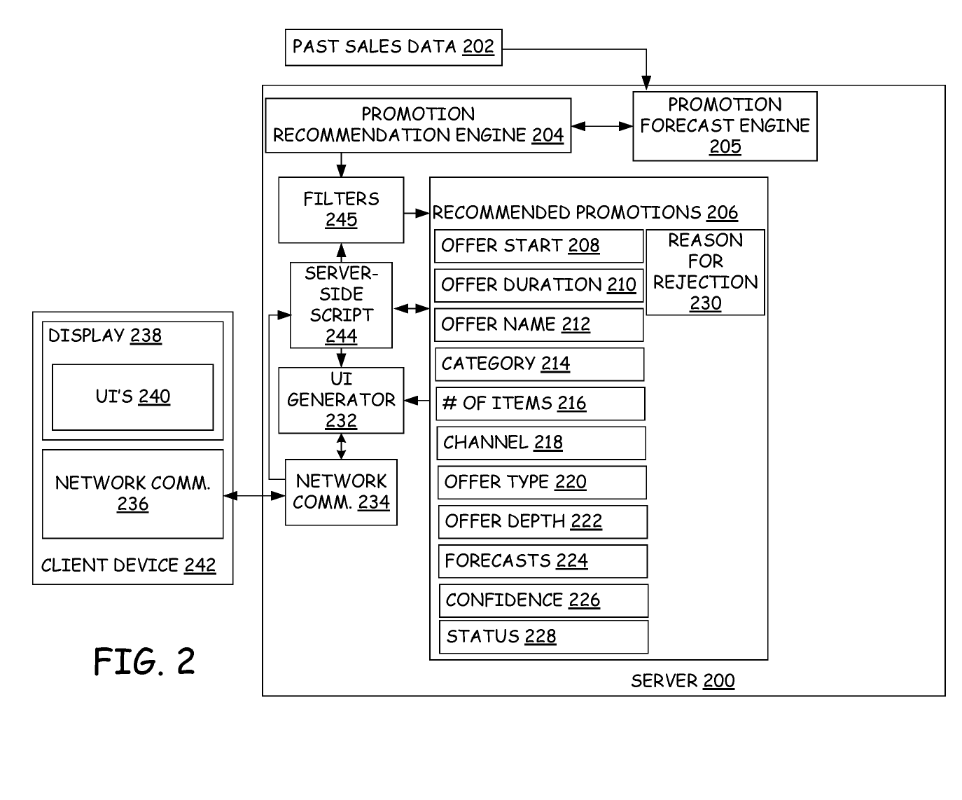

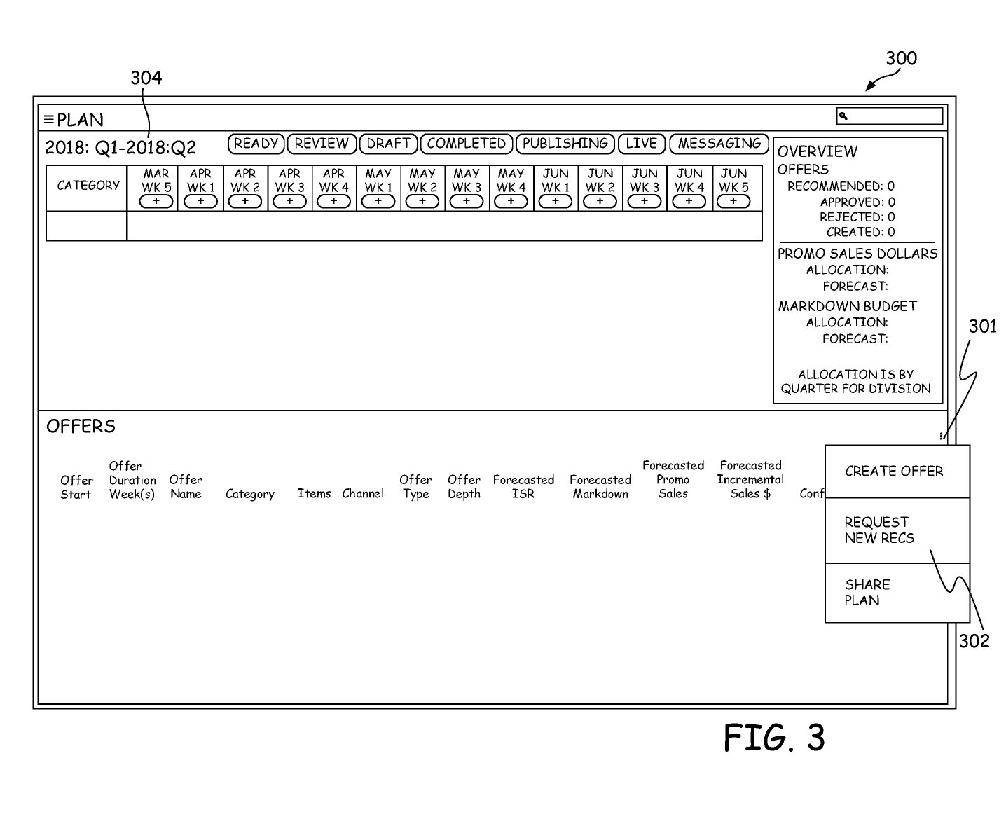

FIG. 1 provides a flow diagram of a method in accordance with one embodiment and FIG. 2 provides a block diagram of a system used with the present embodiments to automatically filter recommended offers based on a rejection of a single offer. At step 102 of FIG. 1, a request for new promotion recommendations sent through a user interface 240 on display 238 of client device 242 is received by server-side scripts 244 on a server 200. FIG. 3 provides an example user interface 300 showing a control 302 for requesting promotion recommendations for a time period specified by a time selection control 304. In accordance with one embodiment, control 302 is displayed in response to the selection of a menu control 301.

In response to the request for promotion recommendations, server-side scripts 244 retrieves all previously rejected offers for the time period from a list of recommended promotions 206. When this is the first request for recommended promotions, there will be no recommended promotions 206 for the time period and as such, there will be no rejected promotion recommendations.

At step 106, server-side scripts 244 server-side script 244 creates a filter 245 that will be used to remove promotions recommended by a promotion recommendation engine 204 that match at least one aspect of the rejected offers. In accordance with one embodiment, a matching promotion is one that has all the same attributes as a rejected promotion or that differs from a rejected promotion only because the matching promotion has a different start date than the rejected promotion. In other embodiments, a matching promotion can be any promotion with at least one attribute that matches an attribute of the rejected promotion. In accordance with one embodiment, if the reason for rejection 230 is tied to a particular attribute, all promotions with the same particular attribute are considered matching promotions.

At step 108, server-side scripts 244 cause promotion recommendation engine 204 to identify a plurality of future recommended promotions 206 for the indicated time span. In accordance with one embodiment, promotion recommendation engine 204 identifies the promotions by generating a list of possible promotions and sending each of the possible promotions to a promotion forecast engine 205, which forecasts the amount of sales that will be achieved under each promotion using past sales data 202 and one or more demand models. Using this forecasted sales data, promotion recommendation engine selects the promotions that will result in the best improvement in a desired financial measure, such as the promotions that will provide the highest income or the highest margin, for example.

At step 110, the future recommended promotions identified by promotion recommendation engine 204 are filtered using filter 245 to remove all recommended promotions that match at least one aspect of a previously rejected promotion for the time span. In accordance with one embodiment, a matching promotion is one that has all the same attributes as a rejected promotion or that differs from a rejected promotion only because the matching promotion has a different start date than the rejected promotion. In other embodiments, a matching promotion can be any promotion with at least one attribute that matches an attribute of the rejected promotion. In accordance with one embodiment, if the reason for rejection 230 is tied to a particular attribute, all promotions with the same particular attribute are considered matching promotions. The resulting filtered promotions are stored as recommended promotions 206.

Each future recommended promotions 206 includes a set of promotion attributes such as an offer start date 208, an offer duration 210, an offer name 212, a category 214, a number of items impacted by the offer 216, a channel 218, an offer type 220, an offer depth 222, a financial forecast 224, a confidence level 226, and a status 228, for example. Offer start date 208 is the date on which the promotion begins, and offer duration 210 is the temporal length of the promotion, which in some embodiments is measured in weeks. Category 214 indicates the categories of products affected by the promotion. Offer type 220 indicates the type of offers, such as percent off, free gift, fixed price, or BOGO (Buy One Get One Free). Offer depth 222 indicates the effect of the promotion on pricing, such as the percent off (20% or 30%, for example) or the promotional price. Channel 218 indicates where the promotion can be redeemed such as online or in-store. Financial forecasts 224 include predictions regarding the financial impact of the promotion such as forecasted Incremental Sales Ratio (ISR), forecasted markdown, forecasted promotional sales in dollars, and forecasted incremented sales in dollars. Confidence level 226 indicates the level of confidence that promotion recommendation engine 204 has in the financial forecast 224. Status 228 indicates a status of the promotion. Initially, each recommended promotion has a blank status. When a promotion is initially accepted, its status is changed to DRAFT and then progresses through various statuses, such as COMPLETED and PUBLISHING before reaching a status of LIVE. When a promotion is specifically rejected, its status is changed to REJECTED.

At step 112, a user interface generator 232 generates a user interface containing a list of promotions, an overview area, and a promotions calendar and then transmits the user interface through a network communication 234 to a network communication interface 236 of a client device 242 to produce a user interface 240 on display 238 of client device 242.

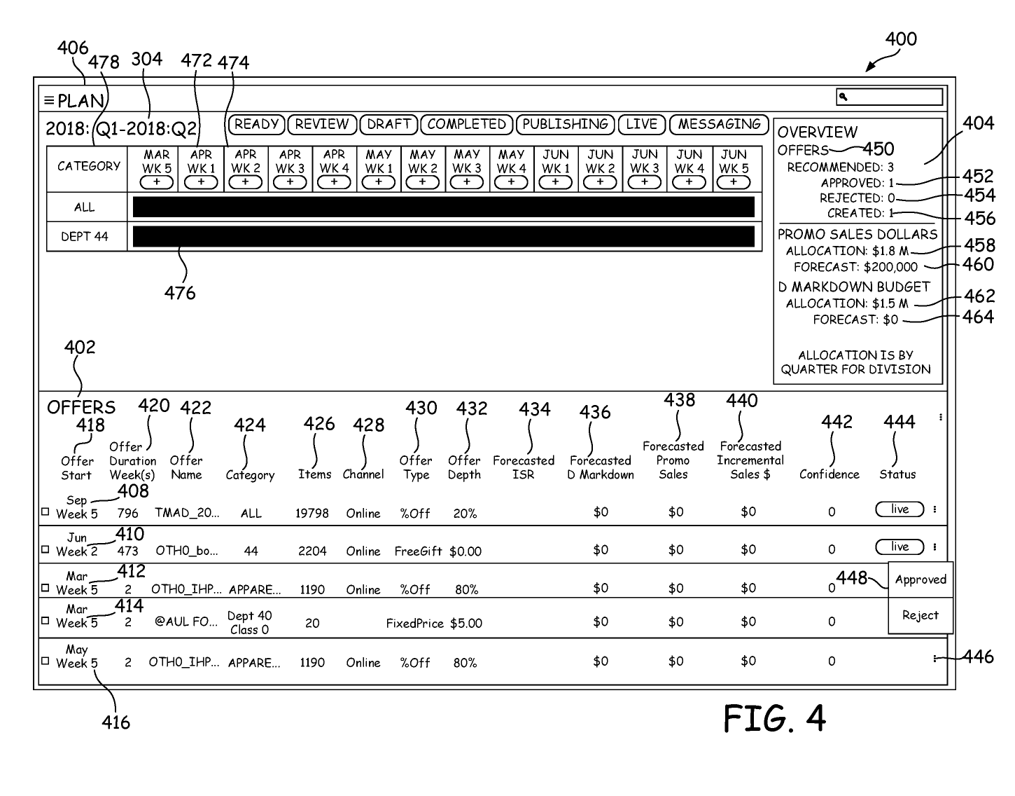

FIG. 4 provides an example user interface 400 produced in step 112. User interface 400 includes an offer or promotion list 402, an overview area 404, and a calendar 406. Promotion list 402 consists of a plurality of promotion rows with each row providing promotion attributes for a separate retail promotion. In FIG. 4, five retail promotions are displayed in promotion list 402 including retail promotions 408, 410, 412, 414 and 416. For each retail promotion, the promotion attributes include an offer start date 418, an offer duration 420, an offer name 422, a category 424, a number of items 426, a channel 428, an offer type 430, an offer depth 432, a forecasted ISR 434, a forecasted markdown 436, a forecasted promotional sales 438, a forecasted incremental sales 440, a confidence level 442, and a status 444. Offer start date 418 is the date on which the promotion begins, and offer duration 420 is the temporal length of the promotion, which in some embodiments is measured in weeks. Category 424 indicates the categories of products affected by the promotion. Offer type 430 indicates the type of offers, such as percent off, free gift, fixed price, or BOGO (Buy One Get One Free). Offer depth 432 indicates the effect of the promotion on pricing, such as the percent off (20% or 30%, for example) or the promotional price. Number of items 426 is the number of unique retail items that can be purchased using the promotion. Channel 428 indicates where the promotion can be redeemed such as online or in-store. Forecasted promotional sales 438 is the total sales amount forecasted during the promotion, forecasted incremental sales 440 is the forecasted additional sales due to the promotion, forecasted ISR 434 is a ratio of forecasted incremental sales 440 to forecasted promotional sales 438, and forecasted markdown 436 is the forecasted total dollar value of the price markdown associated with the promotion.

In addition, each retail promotion includes a respective control, such as control 446 that can be used to perform operations on the retail promotion. For retail promotions that have been recommended but have not been approved or rejected, selecting control 446 causes a menu 448 to be displayed that allows the user to select between approving the retail promotion or rejecting the retail promotion. Thus, control 446 allows the user to approve or reject a single retail promotion.

In promotion list 402, retail promotions 408 and 410 have a status of LIVE indicating that the retail promotions are active and the retail promotions 412, 414 and 416 do not have a status because they have not been approved yet. In accordance with one embodiment, any retail promotion that has an Offer Start date that is in the future is considered to be an inactive retail promotion.

As shown in FIG. 4, step 112 of generating the user interface includes identifying promotions for different time periods within the selected time span 470 including promotions that have different start dates and promotions that have the same start date but different durations. For example, promotions 412 and 416 are for different time periods because they have different Offer Start dates 418.

Overview area 404 includes a count of the number of offers recommended 450, the number of offers approved 452, the number of offers rejected 454, and the number of offers created 456, as well as an allocated promotional sales amount 458, forecasted promotional sales amount 460, a markdown budget allocation amount 462 and a markdown budget forecasted amount 464.

The count of recommended offers 450 is a count of the number of offers in offer list 402 that have been recommended to the user but have yet to be approved or rejected. Approved count 452 and rejected count 454 represent the number of offers that have been approved or rejected, respectively, using control 446 for the offer. Created count 456 represents the number of offers that were manually created by the user instead of being recommended to the user. Promotional sales allocation amount 458 represents the amount budgeted for the division for the quarter for promotional sales and forecasted promotional sales 460 represents the forecasted promotional sales 438 for all offers that have been approved for the quarter for the division. Markdown allocation amount 462 represents the markdown budget set for the division for the quarter and markdown forecast amount 464 represents the sum of forecasted markdowns 436 for all promotions that have been approved for the division for the quarter. Calendar 406 includes a calendar range or span 470 and week headings for each week in span 470, such as week headings 472 and 474. Each approved promotion is inserted in calendar 406 as a separate row with a spanning box, such as spanning box 476 that spans each of the weeks during which the approved promotion will be active. Each promotion also includes a category 478 indicating the categories that the promotion covers.

Returning to FIG. 1, at step 114, an indication from a control 446 is used to reject a promotional offer in user interface 400. The selection of control 446 is passed through network communication links 236 and 234 to a server-side script 244 running on server 200. At step 116, server-side script 244 causes user interface generator 232 to generate a user interface to request reasons for the rejection. This user interface is transmitted through network communication links 234 and 236 and is displayed on display 238 of client device 242.

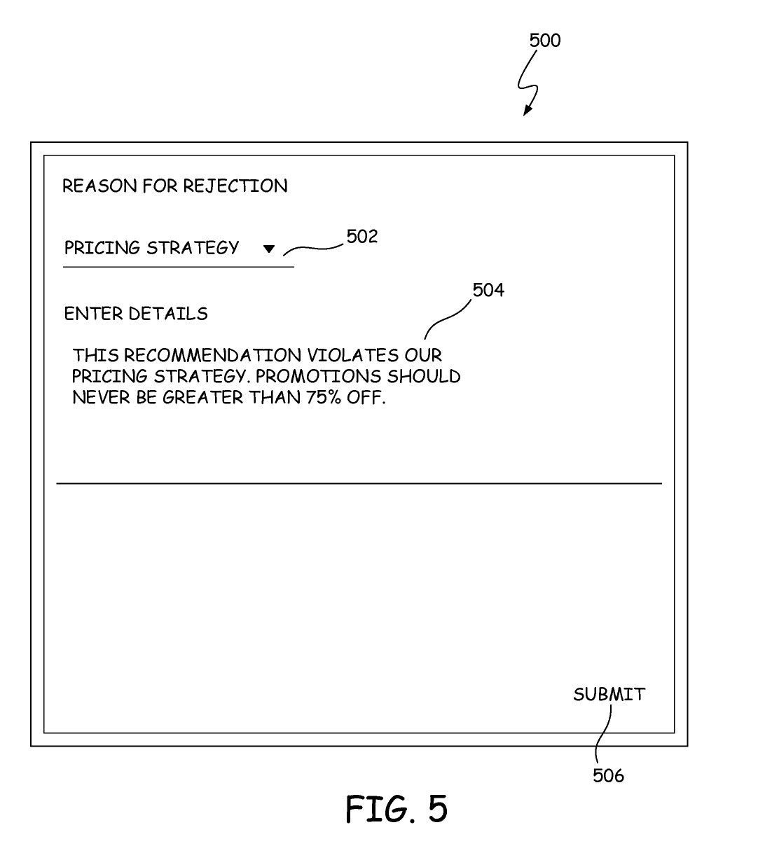

FIG. 5 provides an example user interface 500 that requests the reasons for rejection. User interface 500 includes a pulldown menu 502 that includes a list of predefined reasons that a user can pick from. User interface 500 also includes a free text field 504 in which users may enter detailed reasons for rejecting the promotion. A SUBMIT control button 506 in user interface 500 allows a user to submit the reasons for rejection to server-side script 244, which stores the reasons for the rejection of the recommended promotion as reason for rejections 230 at step 118.

At step 120, the status of the rejected offer, the single offer that control 446 was used to reject, is changed to rejected in recommended promotions 206 of server 200. In accordance with some embodiments, after step 120, server-side scripts 244 cause all matching inactive recommended promotions 206 to be removed so that they will no longer appear in the list of offers 402. Thus, the matching inactive promotions will be removed from the user interface without further interactions from the user. The user only has to reject a single offer to cause other matching inactive offers to be removed. In accordance with one embodiment, the removal of the matching offers is not considered to be a rejection of those offers. As such, overview area 404 does not increase rejected offers 454 to indicate that more offers have been rejected when the matching offers are removed but instead reduces the number of recommended offers 450 to reflect the reduction in the recommended promotions 206 caused by the filtering.

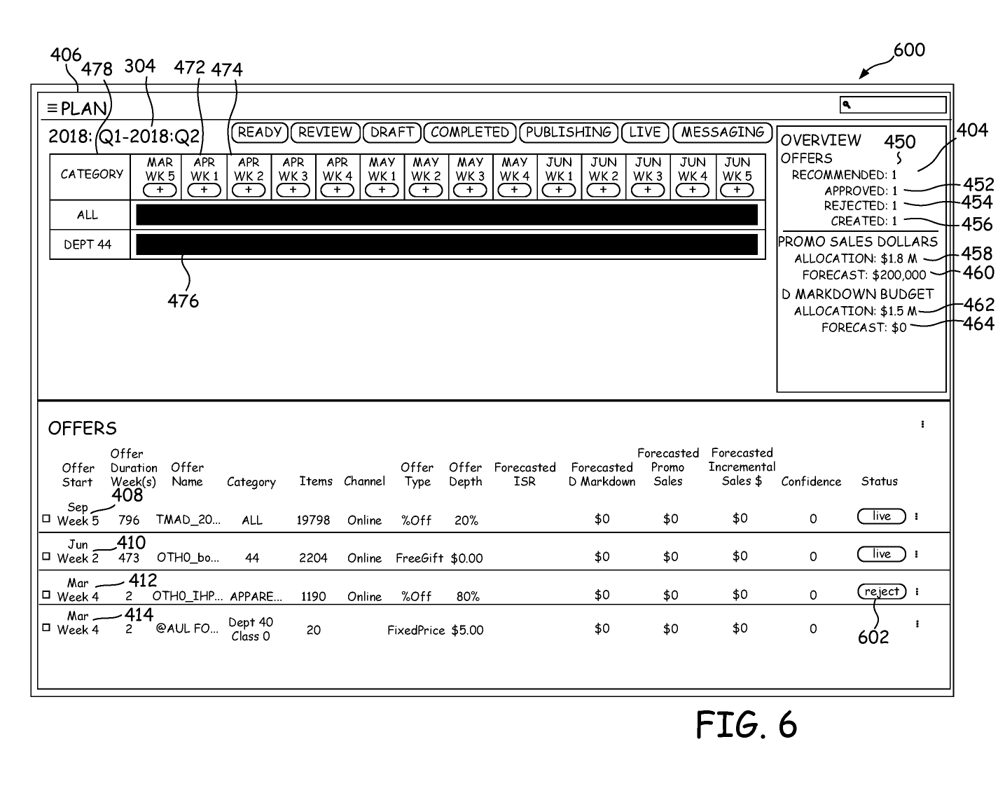

FIG. 6 shows an example of a user interface 600 after promotional offer 412 has been rejected and step 122 has been performed. In user interface 600, the status of offer 412 is shown to have been changed to reject as shown by icon 602. In addition, recommended promotion 416 has been removed from list of offers 402. As shown in FIG. 4, offer 416 was identical to offer 412 except for the offer start date 418. Because offer 416 matched offer 412, server-side script 244 removes offer 416 from recommended promotions 206 at step 120 and as such is not shown when the process of FIG. 1 returns to step 112 to generate user interface 600. In addition, the number of recommended promotions 450 has been reduced by two because of the removal of promotion 416 and the rejection of promotion 412. In addition, the number of rejected promotions 454 has been increased by one because of the rejection of promotion 412. Note that because promotion 414 did not match promotion 412, promotion 414 continues to be displayed in user interface 600 with its attributes unchanged from user interface 400.

After step 122, the process returns to step 112 where the current status values of the promotions are used to generate the user interface with the list of promotions, the overview area and the promotions calendar.

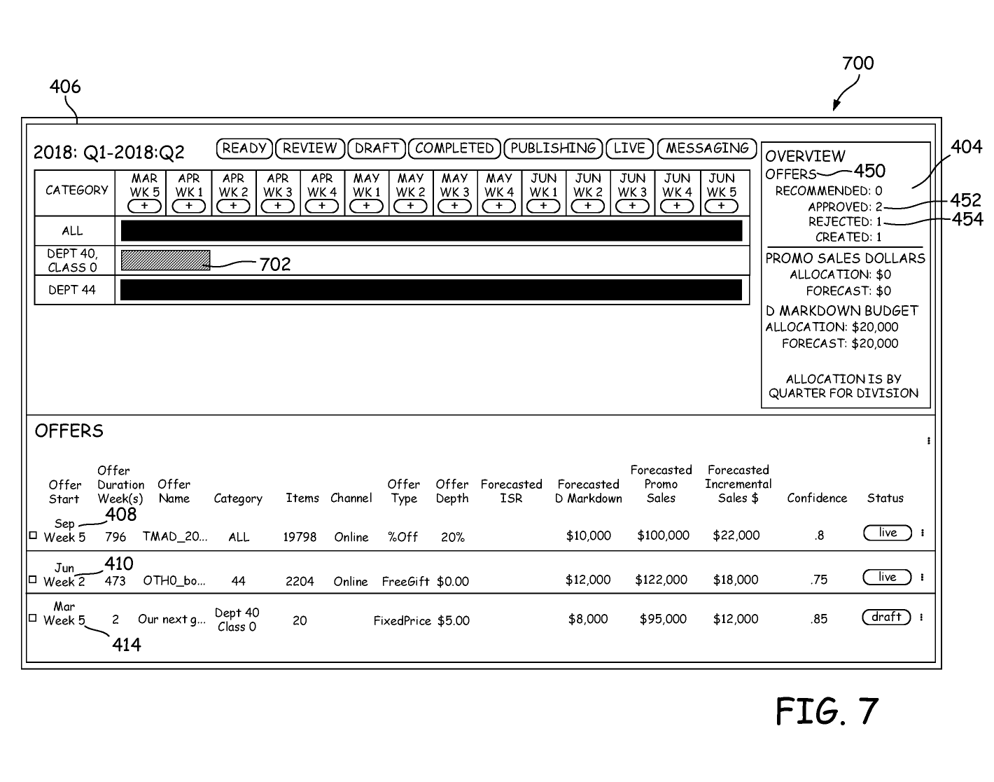

In embodiments in which matching recommended promotions are not removed from recommended promotions 206 at step 122, a similar effect is achieved when a new request for recommended promotions is received at step 102 using control 302. When control 302 is selected after a recommended promotion has been rejected, filter 245 is reconstructed to filter out recommended promotions that match the rejected promotion. As a result, such promotions are filtered out at step 110 so that recommended promotions 206 do not include the matching promotions. One difference between using step 122 to remove matching recommended promotions and using a new request for recommended promotions to remove matching promotions is that when a new request is made, the rejected promotion that caused a change in the filter is also removed from the user interface as shown in FIG. 7, where offer 412 is not shown on the user interface and the number of rejected offers 454 is at zero instead of one since none of the latest set of recommended offers have been rejected.

Control 446 and menu 448 of user interface 400 can also be used to accept an offer. If the user accepts one of the recommended offers, the indication that the user has accepted the offer is received by server-side script 244 at step 124 and server side script 244 changes the status of the accepted promotion to indicate that the promotion was accepted at step 126. In accordance with one embodiment, the status is changed to “draft”. The process then returns to step 112 to regenerate the user interface with the list of promotions, the overview area and the promotions calendar. To generate the user interface for the promotions calendar, the status of each of the recommended promotions 206 is examined and for any promotion that has been accepted, the offer start date 418, the offer duration 420 and the category 424 are used to build one or more graphical structures to represent the offer in calendar 406.

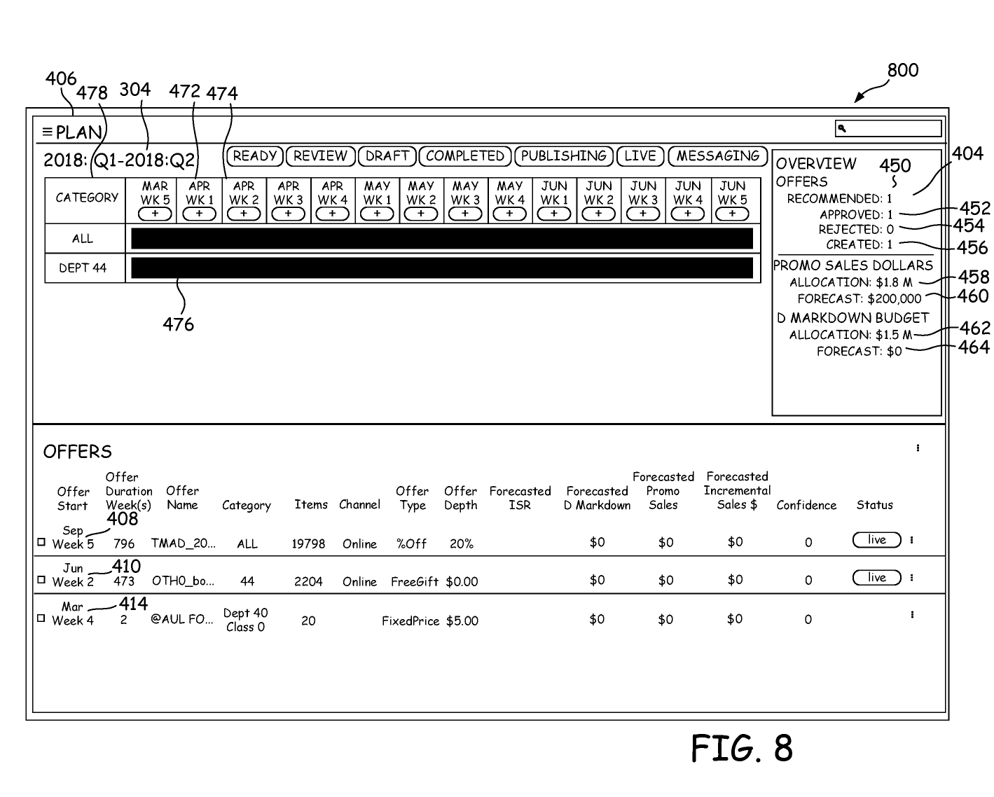

FIG. 8 provides an example of a user interface 800 that is constructed when promotional offer 414 of FIGS. 4, 6 and 7 has been accepted. In FIG. 8, calendar 406 has been modified to include bar 802, which represents offer 414. Bar 802 spans two weeks, March Week 5 and April Week 1, corresponding to the Week 5 offer start date and the two week offer duration of promotional offer 414.

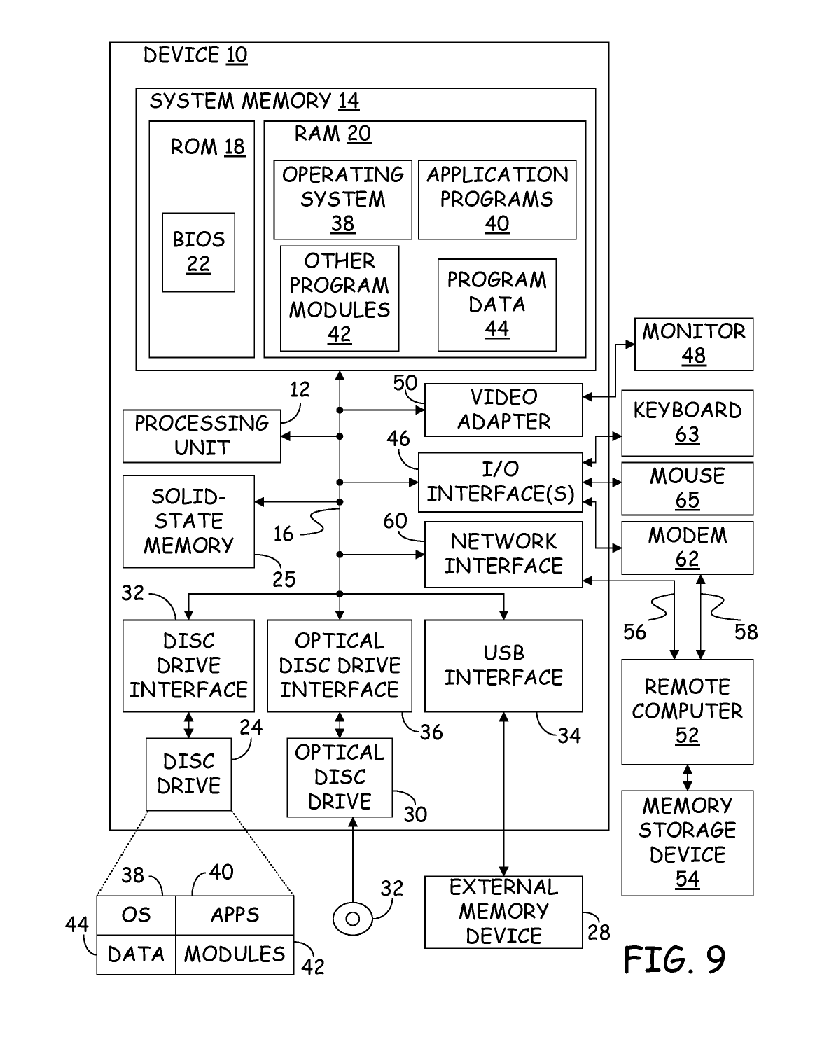

FIG. 9 provides an example of a computing device 10 that can be used as a client device or server device in the embodiments above. Computing device 10 includes a processing unit 12, a system memory 14 and a system bus 16 that couples the system memory 14 to the processing unit 12. System memory 14 includes read only memory (ROM) 18 and random access memory (RAM) 20. A basic input/output system 22 (BIOS), containing the basic routines that help to transfer information between elements within the computing device 10, is stored in ROM 18. Computer-executable instructions that are to be executed by processing unit 12 may be stored in random access memory 20 before being executed.

Embodiments of the present invention can be applied in the context of computer systems other than computing device 10. Other appropriate computer systems include handheld devices, multi-processor systems, various consumer electronic devices, mainframe computers, and the like. Those skilled in the art will also appreciate that embodiments can also be applied within computer systems wherein tasks are performed by remote processing devices that are linked through a communications network (e.g., communication utilizing Internet or web-based software systems). For example, program modules may be located in either local or remote memory storage devices or simultaneously in both local and remote memory storage devices. Similarly, any storage of data associated with embodiments of the present invention may be accomplished utilizing either local or remote storage devices, or simultaneously utilizing both local and remote storage devices.

Computing device 10 further includes a hard disc drive 24, an external memory device 28, and an optical disc drive 30. External memory device 28 can include an external disc drive or solid state memory that may be attached to computing device 10 through an interface such as Universal Serial Bus interface 34, which is connected to system bus 16. Optical disc drive 30 can illustratively be utilized for reading data from (or writing data to) optical media, such as a CD-ROM disc 32. Hard disc drive 24 and optical disc drive 30 are connected to the system bus 16 by a hard disc drive interface 32 and an optical disc drive interface 36, respectively. The drives and external memory devices and their associated computer-readable media provide nonvolatile storage media for the computing device 10 on which computer-executable instructions and computer-readable data structures may be stored. Other types of media that are readable by a computer may also be used in the exemplary operation environment.

A number of program modules may be stored in the drives and RAM 20, including an operating system 38, one or more application programs 40, other program modules 42 and program data 44. In particular, application programs 40 can include programs for implementing promotion forecast engine 205, promotion recommendation engine 204, ui generator 232 and server-side scripts 244, for example. Program data 44 may include data such as past sales data 202, recommended promotions 206, and filters 245, for example.

Input devices including a keyboard 63 and a mouse 65 are connected to system bus 16 through an Input/Output interface 46 that is coupled to system bus 16. Monitor 48 is connected to the system bus 16 through a video adapter 50 and provides graphical images to users. Other peripheral output devices (e.g., speakers or printers) could also be included but have not been illustrated. In accordance with some embodiments, monitor 48 comprises a touch screen that both displays input and provides locations on the screen where the user is contacting the screen.

The computing device 10 may operate in a network environment utilizing connections to one or more remote computers, such as a remote computer 52. The remote computer 52 may be a server, a router, a peer device, or other common network node. Remote computer 52 may include many or all of the features and elements described in relation to computing device 10, although only a memory storage device 54 has been illustrated in FIG. 7. The network connections depicted in FIG. 9 include a local area network (LAN) 56 and a wide area network (WAN) 58. Such network environments are commonplace in the art.

The computing device 10 is connected to the LAN 56 through a network interface 60. The computing device 10 is also connected to WAN 58 and includes a modem 62 for establishing communications over the WAN 58. The modem 62, which may be internal or external, is connected to the system bus 16 via the I/O interface 46.

In a networked environment, program modules depicted relative to the computing device 10, or portions thereof, may be stored in the remote memory storage device 54. For example, application programs may be stored utilizing memory storage device 54. In addition, data associated with an application program may illustratively be stored within memory storage device 54. It will be appreciated that the network connections shown in FIG. 9 are exemplary and other means for establishing a communications link between the computers, such as a wireless interface communications link, may be used.

Although elements have been shown or described as separate embodiments above, portions of each embodiment may be combined with all or part of other embodiments described above.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms for implementing the claims.

What is claimed is:

1. A computer-implemented method comprising:
providing a user interface comprising:
a promotion list comprising a first inactive retail promotion and a first control for approving or rejecting the first inactive retail promotion;
receiving from the first control an indication that the first inactive retail promotion is rejected; and
in response to the received indication, creating a filter to prevent inactive retail promotions that match at least one aspect of the first inactive retail promotion from being placed in a second promotion list.

2. The computer-implemented method of claim 1 wherein the at least one promotion attribute for the first inactive retail promotion comprises a status and wherein the method further comprises in response to the received indication, changing in the value of the status attribute for the first inactive retail promotion.

3. The computer-implemented method of claim 1 further comprising in response to the received indication removing a second inactive retail promotion from the promotion list that matches the first retail promotion.

4. The computer-implemented method of claim 3 wherein providing the user interface further comprises providing an overview area that includes a number of recommended promotions and a number of rejected promotions and in response to receiving the indication, increasing the number of rejected promotions by one and reducing the number of recommended promotions by at least two.

5. The computer-implemented method of claim 3 wherein the promotion list further comprises at least one promotion attribute for a third inactive retail promotion and a third control for approving or rejecting the third inactive retail promotion and wherein in response to the received indication, the at least one promotion attribute for the third inactive retail promotion continues to be displayed in the promotion list.

6. The computer-implemented method of claim 5 further comprising:
receiving from the third control an indication that the third inactive retail promotion is approved; and
in response to the received indication that the third inactive retail promotion is approved, adding a marker for the third inactive retail promotion to a calendar of promotions.

7. The computer-implemented method of claim 6 wherein at least a portion of the calendar is shown on a same screen as the promotion list.

8. A computing device comprising:
a memory; and
a processor, executing instructions to perform steps comprising:
identifying a first retail promotion for a first time period;
generating a first user interface that displays the first retail promotion together with a control for approving or rejecting the first retail promotion; and
receiving an indication that the control for the first retail promotion has been used to reject the first retail promotion and in response, creating a filter to prevent retail promotions that match at least one aspect of the first retail promotion from being displayed in a second user interface.

9. The computing device of claim 8 further comprising in response to receiving the indication that the first retail promotion has been rejected, altering the first user interface to remove a second retail promotion from the first user interface where the second retail promotion matches at least one aspect of the first retail promotion.

10. The computing device of claim 9 wherein generating the first user interface further comprises providing an overview area in the user interface that displays how many retail promotions are currently recommended and wherein in response to receiving the indication that the first retail promotion has been rejected, further altering the first user interface to indicate g that at least two fewer retail promotions are currently recommended.

11. The computing device of claim 9 wherein generating the first user interface further comprises generating the first user interface so that the first user interface displays a third retail promotion and wherein altering the first user interface comprises altering the first user interface so that the third retail promotion appears the same after the first user interface is altered.

12. The computing device of claim 11 wherein generating the first user interface comprises generating the first user interface so that the first user interface displays a control for approving or rejecting the third retail promotion.

13. The computing device of claim 12 further comprising receiving an indication that the control for the third retail promotion has been used to approve the third retail promotion and in response further altering the first user interface so that the third retail promotion is displayed with a status marker indicating that the third retail promotion has been approved.

14. The computing device of claim 13 wherein altering the first user interface further comprises altering the first user interface so that the first user interface displays the third retail promotion in a calendar of promotions.

15. A computer-implemented method comprising:
generating a user interface comprising at least one recommended promotion and an overview area containing a count of a number of recommended promotions and a count of a number of rejected promotions;
receiving an indication that a user has rejected a single recommended promotion;
in response to the received indication, generating a second user interface in which the displayed count of the number of recommended promotions is decreased by at least two.

16. The computer-implemented method of claim 15 wherein generating the second user interface further comprises including a marker proximate the single recommended promotion to indicate that the single recommended promotion has been rejected.

17. The computer-implemented method of claim 16 wherein the at least one recommended promotion comprises a second recommended promotion and wherein generating the second user interface comprises removing the second recommended promotion from the second user interface.

18. The computer-implemented method of claim 17 wherein the at least one recommended promotion comprises a third recommended promotion and wherein generating the second user interface comprises including the third recommended promotion in the second user interface.

19. The computer-implemented method of claim 18 wherein including the third recommended promotion in the second user interface comprises including a control to approve or reject the third recommended promotion.

20. The computer-implemented method of claim 19 further comprising receiving an indication that the control has been used to approve the third recommended promotion and in response generating a third user interface in which the third recommended promotion is shown in a calendar of promotions.
